(19) United States
(12) Patent Application Publication
(10) Pub. No.: US 2007/0232139 A1
(43) Pub. Date: Oct. 4, 2007

(54) Curved tab for a lamp socket body

(75) Inventor: Ismael Garcia, Chicago, IL (US)

Correspondence Address: GREER, BURNS & CRAIN, 300 S WACKER DR, 25TH FLOOR, CHICAGO, IL, 60606, US

(73) Assignee: Christiana Industries. LLC

(21) Appl. No.: 11/393,147

(22) Filed: Mar. 29, 2006

(51) Int. Cl. H01R 13/40

(52) U.S. Cl. 439/587

(57) ABSTRACT

A lamp socket body adapted for receiving a plurality of lead wires, the body including a terminal receiving portion having at least one sidewall, at least one slot in the sidewall for receiving a lead wire, and a tab in the slot, the tab having a curved distal end.

### FIELD OF THE INVENTION

The present curved tab for a lamp socket body relates to lamp sockets, and in particular, sealed lamp sockets useful in automotive lighting.

### BACKGROUND OF THE INVENTION

Conventional lamp sockets comprise a socket body having a lamp receiving portion, a terminal receiving portion, and a partition therebetween. The partition has at least one opening for receiving at least one terminal. A lead wire is connected to each of the at least one terminals by means of a crimp cradle to provide power to the terminal and lamp. Such lamp sockets are disclosed in commonly-owned United States Publication No. 2004/0257810 A1, which is herein incorporated by reference in its entirety.

The terminal receiving portion of prior art lamp sockets generally includes a sidewall having a plurality of slots through which the lead wires extend. Preferably, the socket is sealed with a potting resin that fills the terminal receiving portion, surrounding the at least one terminal and lead wire attached thereto, holding them in place and preventing them from becoming contaminated by the outside environment. However, in prior art lamp sockets with sidewall slots, uncured potting resin can escape through the slots that are not engaged by a lead wire, causing leakage.

Some current lamp sockets provide removable tabs in the sidewall slots in order to prevent the potting material from leaking outside of the terminal accepting portion. However, these sockets require an extra step during assembly, in which tabs must be removed from each slot receptive of a lead wire. Such an extra step can increase the final cost of the socket and also increase manufacture time.

Accordingly, there is a need for an improved lamp socket body having a terminal receiving portion that includes a tab that will prevent potting material from escaping the socket body, protect the lead wires from damage, and that does not require an extra step to remove the tab from the body.

### SUMMARY OF THE INVENTION

The present lamp socket body provides an efficient and cost-effective device to contain potting material within the terminal receiving portion sidewall. Also, the present lamp socket body protects the lead wires from excessive bending as they exit the socket body. In addition, the present socket body allows for insertion of a lead wire into a sidewall slot without an extra tab removal step.

Specifically, the present lamp body is adapted for receiving a plurality of lead wires, and includes a terminal receiving portion having at least one sidewall, at least one slot in the sidewall for receiving a lead wire, and a tab in the slot, the tab having a curved distal end.

In addition, a method for assembling a lamp socket is provided, the socket including a body having at least one terminal having a lead wire, a lamp receiving portion and a terminal receiving portion, the terminal receiving portion having at least one sidewall, at least one slot in the sidewall for receiving a lead wire, and a tab in the slot, the tab having a curved distal end, the method including the steps of inserting the terminal into the socket body, the terminal being connected to the lead wire, inserting the lead wire into a distal end of the slot, pushing the lead wire axially onto the curved distal end of the tab, causing the tab to bend at its proximal end, and continuing to push the lead wire towards a proximal end of the slot.

### BRIEF DESCRIPTION OF THE SEVERAL VIEWS OF THE DRAWINGS

FIG. 1 is an isometric view of an unpotted lamp socket and a socket body having curved tabs according to the present invention showing terminals and lead wires inserted therein;

FIG. 2 is a cross-section of the lamp socket of FIG. 1, without terminals or lead wires;

FIG. 3 is an enlarged partial view of the curved tab shown in FIG. 2;

FIG. 4 is a side view of a terminal receiving portion sidewall of the lamp socket body of FIG. 2; and

FIG. 5 is an enlarged partial view of the terminal receiving portion of the lamp socket body of FIG. 2, showing the curved tab in upright and bent positions.

### DETAILED DESCRIPTION OF THE INVENTION

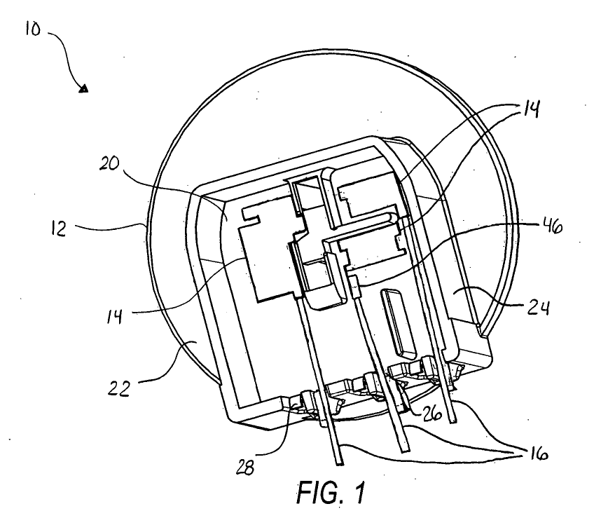

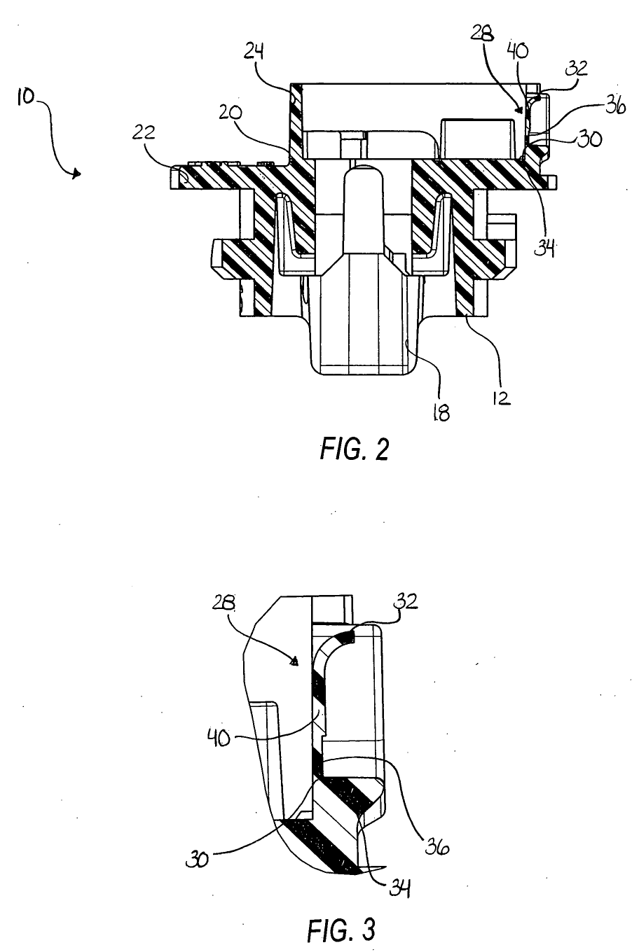

Referring to FIGS. 1 and 2, a lamp socket is generally designated 10, and includes a socket body 12 adapted for receiving a plurality of terminals 14 and a plurality of lead wires 16. The socket body 12 is preferably injection molded of a lightweight and durable plastic, although it is appreciated that other materials with similar insulating properties may be alternatively used. The socket body 12 includes a lamp receiving portion 18, a terminal receiving portion 20, and a partition 22 therebetween. As is known in the art, the lamp receiving portion 18 is adapted for receiving a lamp (not shown). It is contemplated that the lamp receiving portion 20 can be configured for receiving any type of automobile lamp.

The terminal receiving portion 20 has at least one sidewall 24 and at least one slot 26 in the sidewall, each slot adapted for receiving at least one lead wire 16. However, it is recognized that the some of the slots may not receive any lead wires. A removable tab 28 is located in each of the slots 26. As known in the art, the sidewall 24 is generally perpendicular to the partition 22, and forms an enclosure for receiving resinous potting material.

Referring to FIGS. 1 and 2, each of the plurality of terminals 14 is inserted into a corresponding opening (not shown) in the partition 22. The lead wires 16 are attached to the terminals 14 for providing power and ground to the terminals. As best seen in FIG. 1, each of the lead wires 16 passes through respective slots 26.

Tab 28 has a proximal end 30 and a curved distal end 32 (best seen in FIGS. 2 and 3). The distal end 32 preferably curves outwardly, in order to provide a cammed surface for engagement with a lead wire 16. The proximal end 30 of the tab 28 is preferably integrally formed with the socket body 12 at a proximal end 34 of the slot 26. Integrally forming the tab 28 with the socket body 12 allows the socket body to be economically molded. Tab 28 further includes an optional reduced thickness neck portion 36 at the proximal end 30. The tab 28 is adapted to be bent over or separated at the neck 36. When the tab 28 is bent over (as shown in FIG. 5), the lead wire 16 rests on the tab adjacent the proximal end 34 of the slot 26. Because the neck 36 of the tab 28 is thinner in comparison to the rest of the tab, only a slight amount of pressure needs to be applied on the tab by the lead wire 16 in order to bend the tab to the desired position. Whereas the neck portion is preferred, it is not required. Further, other means could be provided such as perforations to accomplish the same function as the neck portion. When fully bent, the tab 28 is generally perpendicular to the sidewall 24, as shown in FIGS. 1 and 5. The tab 28 is shorter than the height of the sidewall 24, which facilitates pushing the lead wires 16 onto the tab and into the slot 26.

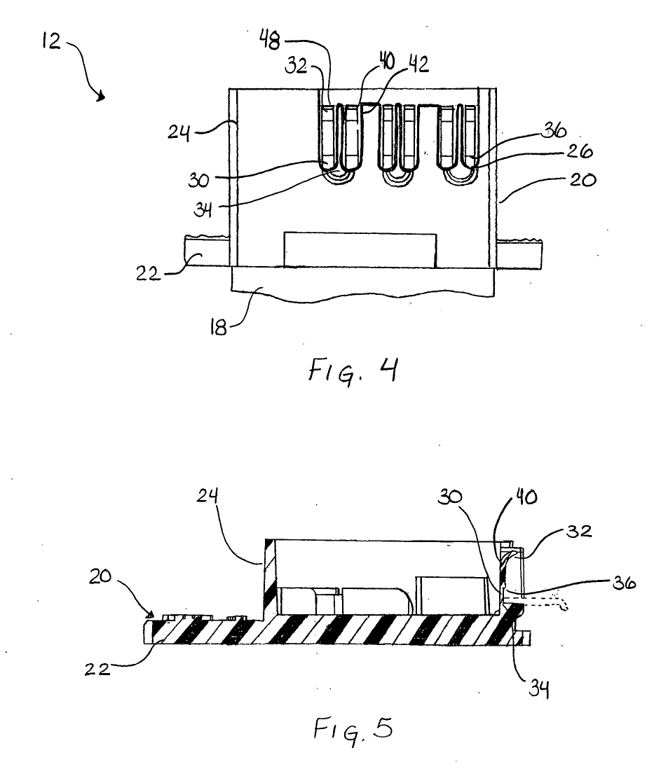

Referring now to FIGS. 1 and 4, tab 28 includes edges 40 that are separated from edges 42 of slot 26. Slight axial pressure on the lead wire 16 easily bends the tab 28, because the tab is only connected to the socket body at the proximal end 34 of the slot 26.

A method for assembling the lamp socket body 12 is provided. First, each of the plurality of terminals 14 is inserted into the socket body 12. Each of the terminals 14 is connected to one of the lead wires 16 by means of a crimp cradle 46, as is known in the art. Each of the lead wires 16 is then inserted into a distal end 48 of one of the slots 26, and the lead wire is pushed in an axial direction onto the curved distal end 32 of the tab 28. The curved end 32 functions as a cam to cause the tab to bend at the neck portion 36. As the lead wire 16 is pushed towards the proximal end 34 of the slot 26, the tab 28 bends to a generally perpendicular orientation with respect to the sidewall 24. Alternatively, the tab 28 may snap and separate at the neck portion 36.

In order to securely hold the lead wires 16 in the slots 26, potting material such as resin (not shown) is injected into the terminal receiving portion 20, encapsulating and environmentally sealing the terminals and the lead wires. The resin is held within the terminal receiving portion 20 by the sidewall 24. The resin is prevented from escaping the sidewall 24 because of the tabs 28 in the unused slots 26.

While a particular embodiment of the curved tab for a lamp socket body has been described herein, it will be appreciated by those skilled in the art that changes and modifications may be made thereto without departing from the invention in its broader aspects and as set forth in the following claims.

1. (canceled)

2. (canceled)

3. (canceled)

4. (canceled)

5. (canceled)

6. (canceled)

7. (canceled)

8. (canceled)

9. (canceled)

10. (canceled)

11. A lamp socket body adapted for receiving at least one lead wire, said body comprising:
a lamp receiving portion;
a terminal receiving portion; and
a partition member positioned between said lamp receiving portion and said terminal receiving portion;
said terminal receiving portion having a recess portion adapted to receive potting material;
said terminal receiving portion having at least one sidewall member with at least one slot therein for placement of a lead wire; and
a tab member positioned in said slot, said tab member adapted to be moveable to a desired position when a lead wire is positioned in said slot.

12. The lamp socket body as described in claim 11 wherein said sidewall has a plurality of slots therein for placement of a plurality of lead wires, at least one of said slots having said moveable tab member thereon.

13. The lamp socket body as described in claim 11 wherein said tab member is integrally formed with said sidewall at a proximal end of said tab member and having a curved portion at a distal end of said tab member.

14. The lamp socket body as described in claim 11 wherein said tab member includes a reduced neck portion at a proximal end of said tab member for easily bending said tab member to said desired position.

15. A lamp socket body adapted for receiving a plurality of lead wires, said body comprising:
a lamp receiving portion;
a terminal receiving portion; and
a partition member positioned between said lamp receiving portion and said terminal receiving portion;
said terminal receiving portion having a cavity therein adapted to receive potting material therein;
said terminal receiving portion having at least one sidewall member with a plurality of slots therein for placement of lead wires; and
a tab member positioned in at least one of said slots, said tab member being integrally formed with said sidewall at a proximal end of said tab member and substantially filling one of said slots in a first position and moveable to a second position opening said slot for placement of a lead wire therein.

16. The lamp socket body as described in claim 15 wherein at least two of said slots have tab members therein.

17. The lamp socket body as described in claim 15 wherein said tab member having a curved distal end.

18. The lamp socket body as described in claim 15 wherein said tab member includes a reduced neck portion at a proximal end of said tab member for easily bending said tab member to said desired position.
